(19) United States
(12) Patent Application Publication
(10) Pub. No.: US 2014/0042776 A1
(43) Pub. Date: Feb. 13, 2014

(54) VEHICLE WITH ANGLED LINK CAB SUSPENSION

(71) Applicant: Gregory Kevin Leeder, Fort Wayne, IN (US)

(72) Inventor: Gregory Kevin Leeder, Fort Wayne, IN (US)

(73) Assignee: International Truck Intellectual Property Company, LLC, Lisle, IL (US)

(21) Appl. No.: 14/114,347

(22) PCT Filed: May 13, 2011
(86) PCT No.: PCT/US11/36438

§ 371 Date: Oct. 28, 2013

(51) Int. Cl. B62D 33/077; B62D 33/06

(52) U.S. Cl. CPC B62D 33/077; B62D 33/0604
USPC 296/190.07

(57) ABSTRACT

A cab suspension system for a vehicle has a first front suspension mount, a second front suspension mount, and a rear suspension system. The first front suspension mount connects to a vehicle frame and to a cab. The second front suspension mount connects to the vehicle frame and to the cab. The rear suspension system has a first angled linking arm, a second angled linking arm, and a spring assembly. The first angled linking arm connects to the vehicle frame and to the cab. The second angled linking arm connects to the vehicle frame and to the cab. The spring assembly connects to the cab and to the vehicle frame. The first angled linking arm and the second angled linking arm are disposed to form a generally V-shape.

### TECHNICAL FIELD

The present disclosure relates to a cab suspension for a vehicle, and more particularly to a cab suspension for a vehicle providing additional location control and vibration isolation of the vehicle cab.

### BACKGROUND

Many vehicles used for transporting freight, such as semi-trucks and straight trucks, and other commercial vehicles often have a vehicle suspension assembly disposed between the wheels and a frame of the vehicle in order to reduce ride roughness and vibrations from imperfections in road surfaces, vibrations from wheel and tire imbalances, radial force variations from vehicle tires as well as other sources of ride roughness. These vehicle suspensions are often relatively stiff, as commercial vehicles often carry heavy loads, therefore the vibration and roughness suppression of the vehicle suspension may not be sufficient to provide a vehicle operator with a comfortable ride. Therefore, many commercial vehicles additionally have a secondary suspension assembly, or a cab suspension assembly, disposed between the frame of the vehicle and a cab of the vehicle. The cab suspension assembly provides further vibration isolation from both road surface generated vibrations and engine generated vibrations.

Many current cab suspension assemblies for commercial vehicles utilize two front elastomer cab mounts and a rear suspension system. The rear suspension system of the cab suspension assembly typically has at least one air spring, a lateral link having a first end mounted to the cab and a second end mounted to the vehicle frame, and at least one shock absorber.

The two front elastomer cab mounts typically are located near a forward end of a cab and near a lateral periphery of the cab, or to put more plainly, near the front right and left corners of the cab. The front elastomer cab mounts are adapted to provide stiffness and damping in longitudinal, lateral, and vertical directions, thus locating the front of the cab and providing isolation of higher vibration frequencies. The front elastomer cab mounts may have different stiffness values for longitudinal, lateral, and vertical forces, such that the front elastomer cab mounts may be less stiff in a vertical direction than in a longitudinal direction based on desired vibrational isolation.

The rear suspension system typically is disposed near a rear end of the cab and near a lateral center of the cab. The at least one air spring of the rear cab suspension typically has a low stiffness value in a vertical direction in order to provide greater vibration isolation in a vertical direction. The at least one shock absorber is provided to damp low-frequency motion in the vertical direction. The air spring provides little to no stiffness or damping in the lateral or longitudinal direction. The lateral link is adapted to provide stiffness and damping in the lateral direction, thus locating the rear of the cab laterally and providing isolation of higher frequency lateral vibrations. Most current rear suspension systems do not provide any stiffness or damping in the longitudinal direction. Thus, all longitudinal stiffness and damping from the cab suspension assembly is provided by the two front elastomer cab mounts, which locate the cab longitudinally and isolate it from high frequency longitudinal vibrations.

Therefore, a need exists for a cab suspension assembly having a rear suspension system providing longitudinal stiffness and damping.

### SUMMARY

According to one embodiment, a cab suspension system for a vehicle comprises a first front suspension mount, a second front suspension mount, and a rear suspension system. The first front suspension mount connects to a vehicle frame and a cab. The second front suspension mount connects to the vehicle frame and the cab. The rear suspension system has a first angled linking arm, a second angled linking arm, and at least one air spring assembly. A mechanical spring, such as a coil spring, may be used instead of the air spring assembly. The first angled linking arm connects to the vehicle frame and to the cab. The second angled linking arm connects to the vehicle frame and to the cab. The air spring assembly or mechanical spring connects to the cab and to the vehicle frame. The first angled linking arm and the second angled linking arm are disposed to form a generally V-shape.

According to another embodiment, a rear suspension system for a cab mounting system comprises a first angled linking arm, a second angled linking arm, at least one air spring assembly or mechanical spring, and at least one shock absorber. The first angled linking arm connects to a vehicle frame at a first location and to a cab at a second location. The second angled linking arm connects to the vehicle frame at a third location and to the cab at a fourth location. The at least one air spring assembly or mechanical spring connects to the cab and to the vehicle frame in a generally vertical orientation. The at least one shock absorber connects to the cab and to the vehicle frame in a generally vertical orientation.

According to a further embodiment, a rear suspension system for a cab mounting system comprises a generally V-shaped angled linking arm assembly, at least one air spring assembly or mechanical spring, and at least one shock absorber. The generally V-shaped angled linking arm assembly connects to a vehicle frame at a first location and a second location and connects to the cab at a third location. The at least one air spring assembly or mechanical spring connects to the cab and to the vehicle frame in a generally vertical orientation. The at least one shock absorber connects to the cab and to the vehicle frame in a generally vertical orientation.

As described above, the Angled Link Cab Suspension and a Vehicle having this system provides a number of advantages, some of which have been described above and others of which are inherent. Also, modifications may be proposed to the Angled Link Cab Suspension and a Vehicle having this system without departing from the teachings herein.

### BRIEF DESCRIPTION OF THE DRAWINGS

FIG. 1 is a schematic side view of a cab suspension assembly for a vehicle.

FIG. 2 is a schematic top view of the cab suspension assembly of FIG. 1.

FIG. 3 is a schematic end view of the cab suspension assembly of FIG. 1.

### DESCRIPTION OF REFERENCE NUMERALS

10. cab suspension assembly
12. vehicle cab
14. vehicle frame
16. pair of front cab mounts
18. rear suspension system
20a, 20b. angled linking arms
22a, 22b. cab connection
24a, 24b. frame connection
23a, 23b. first elastomer bushing
25a, 25b. second elastomer bushing
26. air spring assembly
28. shock absorber
28a. first shock absorber
28b. second shock absorber

### DETAILED DESCRIPTION

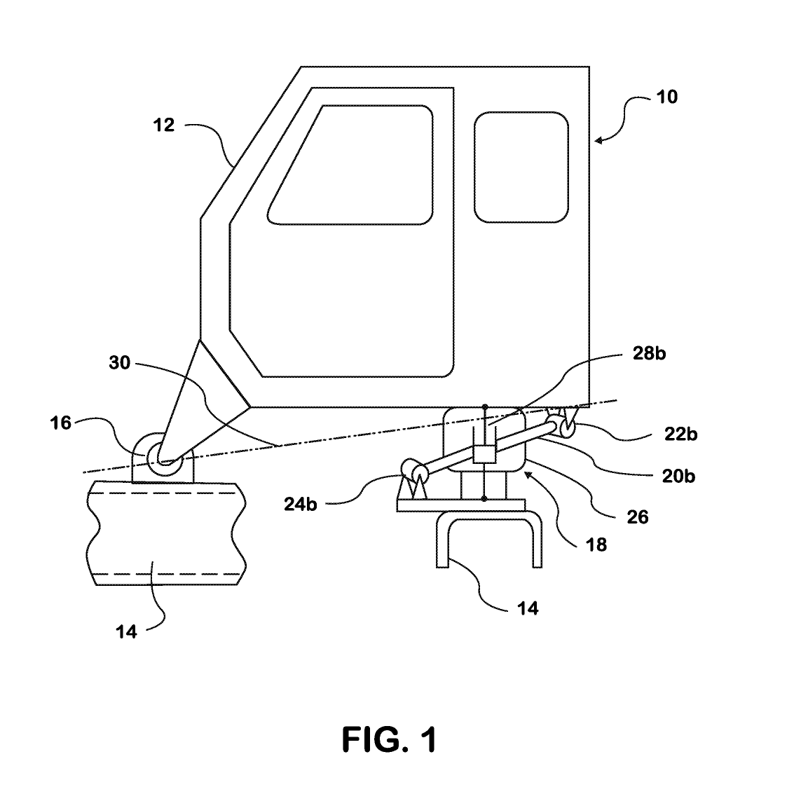

FIG. 1 shows a schematic side view of a cab suspension assembly 10 according to one embodiment. The cab suspension assembly 10 connects a vehicle cab 12 to a vehicle frame 14. The cab suspension assembly 10 comprises a pair of front cab mounts 16 disposed at generally a front left corner of the cab 12 and a front right corner of the cab 12. The pair of front cab mounts 16 are elastomer cab mounts that supply stiffness and damping characteristics selected to control vibrations in a lateral, longitudinal, and vertical direction. Alternately, the pair of front cab mounts 16 may be hydromounts. The cab suspension assembly 10 additionally comprises a rear suspension system 18.

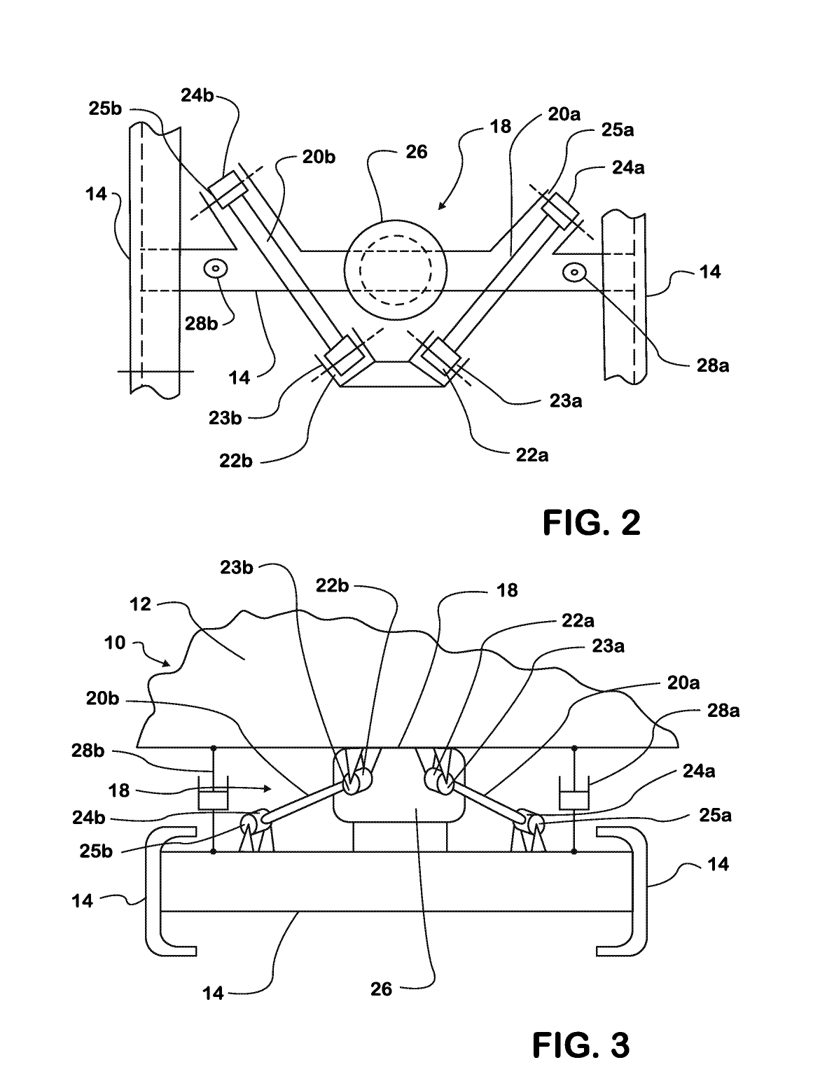

The rear suspension system 18 is shown in greater detail in FIGS. 2 and 3, and comprises angled linking arms 20a, 20b that form a generally V-shaped linkage. As shown, the V-shape formed by the linking arms 20a, 20b has the open end of the V facing towards a front of the vehicle; however, it is also contemplated that the open end of the V may face towards a rear of the vehicle.

The angled linking arms 20a, 20b each have a cab connection 22a, 22b and a frame connection 24a, 24b. The cab connections 22a, 22b each have a first elastomer bushing 23a, 23b where the angled linking arms 20a, 20b connect to the cab connections 22a, 22b. Similarly, the angled linking arms 20a, 20b each have a second elastomer bushing 25a, 25b where the angled linking arms 20a, 20b connect to the frame connection 24a, 24b. The first elastomer bushings 23a, 23b and the second elastomer bushings 25a, 25b have stiffness and damping levels that are determined by the expected loading the vehicle is likely to encounter during operation, such that the elastomer bushings 23a, 23b, 25a, 25b for an on-highway vehicle may be very different than elastomer bushings 23a, 23b, 25a, 25b of an off-highway vehicle. The elastomer bushings 23a, 23b, 25a, 25b are selected to provide stiffness and damping in a lateral, longitudinal, and vertical direction to provide more effective location control and vibration isolation of the vehicle cab 12 from the vehicle frame 14.

The angled linking arms 20a, 20b have a three-dimensional orientation involving lateral, longitudinal, and vertical dimensions. As shown in FIGS. 1 and 3, the cab connections 22a, 22b are generally disposed in a different vertical position that the frame connections 24a, 24b. FIGS. 1 and 2 show that the angled linking arms 20a, 20b have a longitudinal directional component as the frame connections 24a, 24b are located longitudinally forward of the cab connections 22a, 22b. However, it is contemplated that the cab connections 22a, 22b may be located longitudinally forward of the frame connections 24a, 24b. Finally, FIGS. 2 and 3 show that angled linking arms 20a, 20b have a lateral directional component, as the cab connections 22a, 22b are located near a center line of the cab 12, while the frame connections 24a, 24b are located nearer a periphery of the cab 12. However, it is also contemplated that the frame connections 24a, 24b may be located laterally near a center line of the cab 12, while the cab connections 22a, 22b may be located nearer a periphery of the cab 12.

The width of the V-shape of the angled linking arms 20a, 20b may be set to adjust the longitudinal, lateral, and vertical stiffness of the system of angled linking arms 20a, 20b, first elastomer bushings 23a, 23b, and second elastomer bushings 25a, 25b. As best noted in relation to FIG. 2, a wider V-shape will provide increased stiffness in the lateral direction, but will decrease stiffness in the longitudinal direction. This is because a wider V-shape orients the radial stiffness and damping of elastomer bushings 23a, 23b, 25a, 25b into load paths that are aligned more effectively with the lateral direction and less effectively with the longitudinal direction.

Conversely, a narrower V-shape will provide increased stiffness in the longitudinal direction, but will decrease stiffness in the lateral direction. This is because a narrower V-shape orients the radial stiffness and damping of elastomer bushings 23a, 23b, 25a, 25b into load paths that are aligned more effectively with the longitudinal direction and less effectively with the lateral direction.

The side-view angle of the angled linking arms 20a, 20b additionally affects vertical and longitudinal stiffness of the rear suspension system 18. As best noted in relation to FIG. 1, a steeper inclination from the horizontal of the angled linking arms 20a, 20b will provide increased stiffness in the vertical direction, but will reduce stiffness in the longitudinal direction. This is because a steeper inclination orients the radial stiffness and damping of elastomer bushings 23a, 23b, 25a, 25b into load paths that are aligned more effectively with the vertical direction and less effectively with the longitudinal direction. Conversely, a shallower inclination from the horizontal of the angled linking arms 20a, 20b will provide reduced stiffness in the vertical direction, but will increase stiffness in the longitudinal direction. This is because a shallower inclination orients the radial stiffness and damping of elastomer bushings 23a, 23b, 25a, 25b into load paths that are aligned more effectively with the longitudinal direction and less effectively with the vertical direction. As shown, the angled linking arms 20a, 20b are disposed with the cab connections 22a, 22b having a higher vertical position than the frame connections 24a, 24b; however, it is also contemplated that the angled linking arms 20a, 20b may be disposed with the cab connections 22a, 22b having a lower vertical position than the frame connections 24a, 24b.

In addition to the angled linking arms 20a, 20b, the rear suspension system 18 additionally comprises at least one air spring assembly 26. Alternately, the rear suspension system 18 may utilize a mechanical spring such as a coil spring in the location of the at least one air spring assembly 26. The air spring assembly 26 is connected to the frame 14 and the cab 12 and provides resistance to movement in the vertical direction. The rear suspension additionally comprises at least one shock absorber 28 connected to the frame 14 and the cab 12, and may comprise a first shock absorber 28a and a second shock absorber 28b. The shock absorbers 28a, 28b provide damping for vertical movements of the air spring assembly 26. As best noted in relation to FIG. 3, the shock absorbers 28a, 28b may be spaced apart laterally, with wider spacing increasing the damping of roll motions, and narrower spacing providing less roll damping.

Therefore, adjusting the width of the V-shape of the angled linking arms 20a, 20b, the side-view angle of the V-shaped angled linking arms 20a, 20b, the selection of the stiffness for the elastomer bushings 23a, 23b, 25a, 25b, and the selection of the stiffness for the air spring assembly 26 allows the stiffness of the rear suspension system 18 to be adjusted in the lateral, longitudinal, and vertical direction to provide a cab suspension assembly 10 that is optimized based on the intended uses of the vehicle. For example, a vehicle adapted to be used frequently in on-road applications may have a lower stiffness for vertical movement in order to improve ride quality, while a vehicle adapted to be used frequently in off-road applications may have a higher stiffness for vertical movement in order to avoid excessive travel of the cab relative to the frame.

As best shown in FIG. 1, the use of angled linking arms 20a, 20b provides longitudinal load paths at the rear suspension system 18. Therefore, the cab suspension assembly 10 allows longitudinal loads to be distributed between the pair of front cab mounts 16 and the rear suspension system 18. Therefore, based upon the stiffness of the pair of front cab mounts 16 and the positioning of the angled linking arms 20a, 20b to form a V-shaped system of elastomer bushings 23a, 23b, 25a, 25b with side-view inclination angle, the amount of longitudinal force resistance may be distributed between the pair of front cab mounts 16 and the rear suspension system 18. The distribution of longitudinal forces to both the pair of front cab mounts 16 and the rear suspension system 18 allows for better optimization of the ride experienced by a passenger within the vehicle cab 12, as the pair of front cab mounts 16 and the rear suspension system 18 may be tuned based on expected uses of the vehicle. The distribution of longitudinal forces is beneficial in controlling vibration modes that contain a longitudinal component, such as pitching, longitudinal chugging, yaw, and yaw-pitch-roll vibrations. Pitching vibrations in particular may be well controlled by the distribution of longitudinal forces to the rear suspension system 18 by the angled linking arms 20, 20b and the V-shaped system of elastomer bushings 23a, 23b, 25a, 25b with side-view inclination angle.

As best shown in FIG. 2, the longitudinal-lateral load paths at the rear suspension system 18 provided by the angled linking arms 20a, 20b additionally is beneficial in controlling yaw vibrations. Yaw vibrations will be resisted by both angled linking arms 20a, 20b with their elastomer bushings 23a, 25a, 23b, 25b as tension forces will develop in one of the linking arms 20a, 20b, while compression forces will develop in the other one of the linking arms 20a, 20b. Both the compression forces and the tension forces of the linking arms 20a, 20b will provide a restoring force to resist yaw vibrations of the cab 12. Additionally, longitudinal and lateral forces will also be present at the pair of front cab mounts 16 from yaw vibrations and the pair of front cab mounts 16 will provide a restoring force to resist yaw vibrations of the cab 12. Therefore, four restoring forces will applied to the cab 12 when yaw vibrations are present: a tension force from one of the linking arms 20a, a compression force from the other one of the linking arms 20b, and a longitudinal-lateral restoring force from each of the pair of front cab mount 16.

The angled linking arms 20a, 20b additionally affect roll vibrations of the cab 12. As shown in FIG. 1, the linking arms 20a, 20 cause a cab roll axis 30 to be formed running from a midpoint of the left and right front cab mounts 16 to an apex of the V-shape formed by projection along the angled linking arms 20a, 20b. A roll center of the cab 12 is located at a point along the roll axis 30 corresponding to the center of mass of the cab 12 in a longitudinal direction. The apex of the V-shape may be adjusted based on the geometry of the angled linking arms 20a, 20b, particularly the location of the cab connections 22a, 22b and the frame connections 24a, 24b, such that a vertical position and side-view angle of the roll axis 30 may be adjusted. Additionally, the vertical and longitudinal positions of the pair of front cab mounts 16 may also be adjusted to influence the vertical position and side view angle of the roll axis, and the resultant cab roll center. Therefore, the geometry of the angled linking arms 20a, 20b and the pair of front cab mounts 16 affect roll motions of the cab 12, and may be selected such that roll motion of the cab 12 is reduced in magnitude and is directed to a roll axis that reduces the transmission of roll motion to a passenger within the cab 12.

As shown in FIGS. 1-3 the frame connections 24a, 24b are located forward of the cab connections 22a, 22b, however, it is also contemplated that the frame connections 24a, 24b may be located rearward of the cab connections 22a, 22b.

While the angled linking arms 20a, 20b are depicted in FIGS. 1-3 as being separate arms, it is additionally contemplated that a single V-shaped angled linking arm may be provided. The single V-shaped angled linking arm would have a single mounting point at an apex of the V-shape, and a mounting point at each distal end of a leg of the V-shape.

Although the angled link cab suspension is shown as having the pair of front cab mounts 16 and rear suspension system 18 having angled linking arms 20a, 20b, it is also contemplated that the entire arrangement may be reversed, such that the pair of front cab mounts 16 become rear cab mounts, and the rear suspension system 18 having angled linking arms 20a, 20b becomes a front cab suspension system.

While specific embodiments have been described in detail in the foregoing detailed description and illustrated in the accompanying drawings, those with ordinary skill in the art will appreciate that various permutations are possible without departing from the teachings disclosed herein. Accordingly, the particular arrangements disclosed are meant to be illustrative only and not limiting as to the scope of the invention, which is to be given the full breadth of the appended claims and any and all equivalents thereof. Other advantages to the Angled Link Cab Suspension and a Vehicle having this system may also be inherent, without having been described above.

What is claimed is:

1. A cab suspension system for a vehicle having a vehicle frame and a cab, comprising:
a first front cab mount connected to the vehicle frame and to the cab;
a second front cab mount connected to the vehicle frame and to the cab; and
a rear suspension system having a first angled linking arm connected to the vehicle frame at a first end and to the cab at a second end and forming an acute angle relative to a longitudinal axis of the vehicle, a second angled linking arm connected to the vehicle frame at a third end and to the cab at a fourth end and forming an acute angle relative to the longitudinal axis of the vehicle, and at least one spring assembly connected to the cab and to the vehicle frame;
wherein the first angled linking arm and the second angled linking arm are disposed to form a generally V-shape.

2. The cab suspension system for a vehicle of claim 1, wherein:
the at least one spring assembly further comprises at least one air spring.

3. The cab suspension system for a vehicle of claim 1, wherein:
the at least one spring assembly further comprises at least one mechanical spring.

4. The cab suspension system for a vehicle of claim 3, wherein:
the at least one mechanical spring further comprises at least one coil spring.

5. The cab suspension system for a vehicle of claim 1 further comprising:
a first elastomer bushing disposed at a location where the first angled linking arm connects to the vehicle frame;
a second elastomer bushing disposed at a location where the first angled linking arm connects to the cab;
a third elastomer bushing disposed at a location where the second angled linking arm connects to the vehicle frame; and
a fourth elastomer bushing disposed at a location where the second angled linking arm connects to the cab.

6. The cab suspension system for a vehicle of claim 1 further comprising at least one shock absorber connected to the cab and to the vehicle frame.

7. The cab suspension system for a vehicle of claim 1, wherein the first front cab mount and the second front cab mount are elastomer mounts.

8. The cab suspension system for a vehicle of claim 1, wherein the first front cab mount and the second front cab mount are hydromounts.

9. The cab suspension system for a vehicle of claim 1, wherein the first angled linking arm connects to the cab at a higher vertical position than where the first angled linking arm connects to the vehicle frame, and wherein the second angled linking arm connects to the cab at a higher vertical position than where the second angled linking arm connects to the vehicle frame.

10. The cab suspension system for a vehicle of claim 1, wherein the first angled linking arm connects to the cab at a lower vertical position than where the first angled linking arm connects to the vehicle frame, and wherein the second angled linking arm connects to the cab at a lower vertical position than where the second angled linking arm connects to the vehicle frame.

11. The cab suspension system for a vehicle of claim 1, wherein the first angled linking arm connects to the cab at a position nearer a lateral center of the vehicle than where the first angled linking arm connects to the vehicle frame, and wherein the second angled linking arm connects to the cab at a position nearer a lateral center of the vehicle than where the second angled linking arm connects to the vehicle frame.

12. The cab suspension system for a vehicle of claim 1, wherein the first angled linking arm connects to the vehicle frame at a position nearer a lateral center of the vehicle than where the first angled linking arm connects to the cab, and wherein the second angled linking arm connects to the vehicle frame at a position nearer a lateral center of the vehicle than where the second angled linking arm connects to the cab.

13. The cab suspension system for a vehicle of claim 1, wherein the first angled linking arm connects to the vehicle frame at a forward longitudinal position relative to where the first angled linking arm connects to the cab, and wherein the second angled linking arm connects to the vehicle frame at a forward longitudinal position relative to where the second angled linking arm connects to the cab.

14. The cab suspension system for a vehicle of claim 1, wherein the first angled linking arm connects to the cab at a forward longitudinal position relative to where the first angled linking arm connects to the vehicle frame, and wherein the second angled linking arm connects to the cab at a forward longitudinal position relative to where the second angled linking arm connects to the vehicle frame.

15. A rear suspension system for a cab mounting system comprising:
a first angled linking arm connected to a vehicle frame at a first location and a cab at a second location and forming an acute angle with respect to a longitudinal axis of a cab;
a second angled linking arm connected to the vehicle frame at a third location and the cab at a fourth location and forming an acute angle with respect to a longitudinal axis of a cab;
at least one spring assembly connected to the cab and to the vehicle frame in a generally vertical orientation; and
at least one shock absorber connected to the cab and to the vehicle frame in a generally vertical orientation.

16. The rear suspension system for a cab mounting system of claim 15, wherein:
the at least one spring assembly further comprises at least one air spring.

17. The rear suspension system for a cab mounting system of claim 15, wherein:
the at least one spring assembly further comprises at least one mechanical spring.

18. The rear suspension system for a cab mounting system of claim 17, wherein:
the at least one mechanical spring further comprises at least one coil spring.

19. The rear suspension system for a cab mounting system of claim 15, wherein the first angled linking arm and the second angled linking arm are disposed in a generally V-shaped configuration with respect to the longitudinal axis of the cab.

20. The rear suspension system for a cab mounting system of claim 15 further comprising:
a first elastomer bushing disposed at the first location, the first elastomer bushing connecting the first angled linking arm to the vehicle frame;
a second elastomer bushing disposed at the second location, the second elastomer bushing connecting the first angled linking arm to the cab;
a third elastomer bushing disposed at the third location, the third elastomer bushing connecting the second angled linking arm to the vehicle frame; and
a fourth elastomer bushing disposed at the fourth location, the fourth elastomer bushing connecting the second angled linking arm to the cab.

21. A rear suspension system for a cab mounting system comprising:
a V-shaped angled linking arm assembly connected to a vehicle frame at a first location and a second location and connected to a cab at a third location, the V-shape being formed relative to a longitudinal axis of a cab;
at least one spring assembly connected to the cab and the vehicle frame in a generally vertical orientation; and
at least one shock absorber connected to the cab and the vehicle frame in a generally vertical orientation.

22. The rear suspension system for a cab mounting system of claim 21, wherein:
the at least one spring assembly further comprises at least one air spring.

23. The rear suspension system for a cab mounting system of claim 21, wherein:
the at least one spring assembly further comprises at least one mechanical spring.

24. The rear suspension system for a cab mounting system of claim 21, wherein:
the at least one mechanical spring further comprises at least one coil spring.

25. A cab suspension system for a vehicle having a vehicle frame and a cab, comprising:
a first rear cab mount connected to the vehicle frame and to the cab;
a second rear cab mount connected to the vehicle frame and to the cab; and
a front suspension system having a first angled linking arm connected to the vehicle frame at a first end and to the cab at a second end and forming an acute angle relative to a longitudinal axis of the vehicle, a second angled linking arm connected to the vehicle frame at a third end and to the cab at a fourth end and forming an acute angle relative to the longitudinal axis of the vehicle, and at least one spring assembly connected to the cab and to the vehicle frame;
wherein the first angled linking arm and the second angled linking arm are disposed to form a generally V-shape.
